(19) United States
(12) Patent Application Publication
(10) Pub. No.: US 2007/0091044 A1
(43) Pub. Date: Apr. 26, 2007

(54) Liquid crystal display with improved pixel configuration

(75) Inventors: Haeng-Won Park, Gyeonggi-do (KR); Seung-Hwan Moon, Gyeonggi-do (KR); Nam-Soo Kang, Gyeonggi-do (KR); Yong-Soon Lee, Chungcheongnam-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/583,406

(22) Filed: Oct. 18, 2006

(30) Foreign Application Priority Data
Oct. 21, 2005 (KR) 2005-99445

(51) Int. Cl. G09G 3/36

(52) U.S. Cl. 345/88

(57) ABSTRACT

In a liquid crystal display, a liquid crystal panel includes a plurality of pixels. Each of the pixels has a plurality of subpixels corresponding to a red, a green and a blue and is arranged along data lines. The subpixels are formed in pixel regions, which are defined by the data lines and gate lines. First groups of the subpixels are connected to an adjacent left data line and second groups of the subpixels are connected to an adjacent right data line. The data lines are driven by a column inversion driving method such that image data applied to the adjacent data lines have different polarities. Thus, the screen-defects are reduced when the liquid crystal panel is driven by the dot inversion method.

### CROSS-REFERENCE TO RELATED APPLICATION

This application relies for priority upon Korean Patent Application No. 2005-99445 filed on Oct. 21, 2005 the content of which is herein incorporated by reference in its entirety.

### BACKGROUND OF THE INVENTION

1. Field of the Invention

The present invention relates to a liquid crystal display. More particularly, the present invention relates to a liquid crystal display capable of improving display quality and having a reduced number of parts.

2. Description of the Related Art

In general, a liquid crystal display (LCD) includes two substrates, for example a thin film transistor substrate and a color filter substrate, combined with each other and liquid crystals injected between the two substrates. When an electric field is applied to the liquid crystal display and the intensity of the electric field is adjusted, an amount of light transmitted through the two substrates is adjustable, to thereby display a desired image on the liquid crystal display. As a representative display device among flat panel displays, the liquid crystal display is widely implemented in various types of electronics. Of the different types of LCDs, a thin film transistor liquid crystal display (TFT-LCD) employing a thin film transistor as a switching device is most commonly used.

The TFT-LCD includes a plurality of pixels, each of which includes the switching device and is arranged in a matrix configuration. Each of the pixels selectively receives a data voltage corresponding to an image signal through the switching device. The TFT-LCD also includes a gate driver applying a gate-on voltage to a gate line, a data driver applying the image signal to a data line and a control circuit controlling the gate driver and the data driver.

Recently, technologies such as direct mounting of the gate driver on a liquid crystal panel, separate fabrication of the data driver as an integrated circuit and mounting of the integrated circuit on the liquid crystal panel as the data driver, are broadly applied to LCDs.

For a liquid crystal display that has a resolution of M×N, since each of the pixels has three subpixels, the number of sub-pixels is (M×3)×N and the number of data lines is 3M. In order to drive the massive number of sub-pixels, the data driver needs a lot of data driver integrated circuits.

This dramatic increase in the number of data driver integrated circuits creates new problems. For example, the large number of data driver integrated circuit adds to the manufacturing cost and increases the peripheral circuit area of the liquid crystal display.

### SUMMARY OF THE INVENTION

The present invention provides a liquid crystal display capable of reducing the number of data driver integrated circuits.

The present invention also provides a liquid crystal display capable of improving display quality.

In one aspect of the present invention, a liquid crystal display includes a plurality of data lines, a plurality of gate lines extending perpendicularly to the data lines to define a plurality of pixel regions, and a pixel array having a plurality of pixels. Each of the pixels includes a plurality of subpixels corresponding to a red, a green and a blue and is arranged along a direction in which the data lines extend. The subpixels are formed in the pixel regions. First groups of the subpixels are connected to an adjacent left data line and second groups of the subpixels are connected to an adjacent right data line. The data lines are driven by a column inversion driving method such that image data applied to the adjacent data lines have different polarities.

The first groups of the subpixels and the second groups of the subpixels may be alternately arranged along the direction in which the data lines extend.

The first groups of the subpixels may be connected to every other gate lines of the plurality of gate lines, and the second groups of the subpixels may be connected to the gate lines that are not connected to the first groups of the subpixels.

Each of the first groups may have K (K is a positive integer) units of the subpixels, each of the second groups may have K units of the subpixels, and the first and second groups may be alternately arranged along the direction in which the data lines extend.

Each of the first groups may have two subpixels, each of the second groups may have two subpixels and the first and second groups may be alternately arranged along the direction in which the data lines extend.

The first and second groups of the subpixels may be connected to the gate lines except a first gate line of the gate lines. Each of the first groups may have K (K is a positive integer) units of the subpixels and each of the second groups may have K units of the subpixels. The first and second groups may be alternately arranged along the direction in which the data lines extend.

The gate lines may be driven such that the subpixels connected to a next data line are precharged while the image data is applied to the subpixels connected to a current gate line.

In another aspect of the present invention, a liquid crystal display includes a plurality of data lines, a plurality of gate lines extending substantially perpendicularly to the data lines to define a plurality of pixel regions and a pixel array including a plurality of pixels. Each of the pixels has a plurality of subpixels corresponding to a red, a green and a blue and is arranged along a direction in which the data lines extend. The subpixels are formed in the pixel regions.

A first group having K (K is a positive integer) units of the subpixels is connected to an adjacent left data line and a second group having K (K is a positive integer) units of the subpixels is connected to an adjacent right data line. The first and second groups are alternately arranged along a direction in which the data lines extend. The data lines are driven by a column inversion driving method such that image data applied to the adjacent data lines have different polarities.

With the invention, even if the subpixels are driven by the column inversion driving method, the liquid crystal display may prevent the undesirable appearance of a vertical stripe flicker on the liquid crystal panel.

### BRIEF DESCRIPTION OF THE DRAWINGS

The above and other advantages of the present invention will become readily apparent by reference to the following detailed description when considered in conjunction with the accompanying drawings, wherein:

FIG. 1 is a block diagram showing a liquid crystal display according to an exemplary embodiment of the present invention;

FIG. 2 is a timing diagram showing signals for the liquid crystal display of FIG. 1;

FIG. 3 is a circuit diagram showing subpixels in the liquid crystal panel of FIG. 1;

FIG. 4 is a circuit diagram showing a liquid crystal display according to another exemplary embodiment of the present invention; and

FIG. 5 is a circuit diagram showing a liquid crystal display according to another exemplary embodiment of the present invention.

### DESCRIPTION OF THE EMBODIMENTS

It will be understood that when an element or layer is referred to as being “on”, “connected to” or “coupled to” another element or layer, it can be directly on, connected or coupled to the other element or layer, or intervening elements or layers may be present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

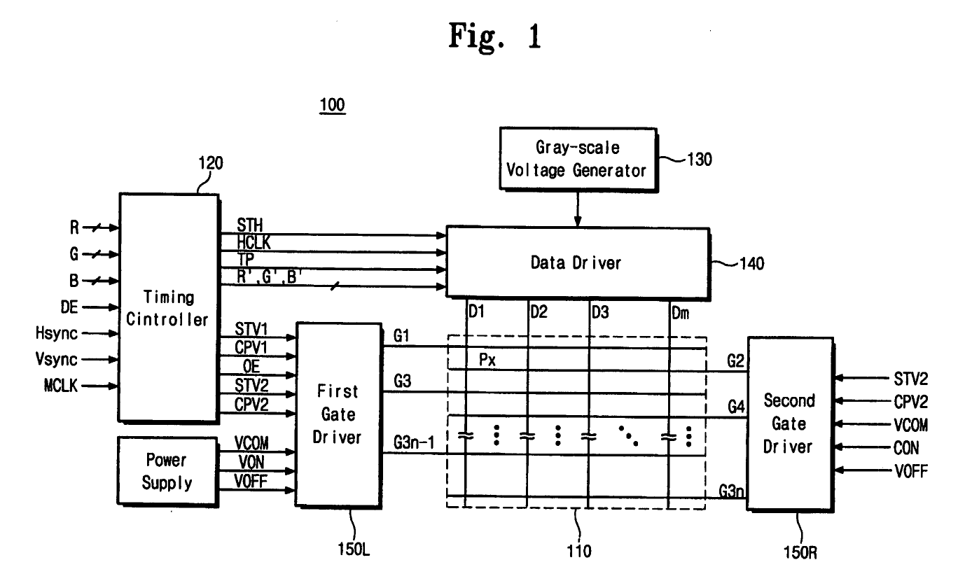

FIG. 1 is a block diagram showing a liquid crystal display according to an exemplary embodiment of the present invention.

Referring to FIG. 1, a liquid crystal display 100 includes a liquid crystal panel 110, a timing controller 120, a gray-scale generator 130, a data driver 140, a first gate driver 150L and a second gate driver 150R.

The liquid crystal panel 110 includes a plurality of data lines D1-Dm extending in a first direction, a plurality of gate lines G1-G3n extending in a second direction substantially perpendicularly to the data lines D1-Dm. A plurality of pixels Px are formed in pixel areas defined by the data lines D1-Dm and the gate lines G1-G3n.

Each of the pixels PX includes a switching transistor electrically connected to a corresponding data line and a corresponding gate line, a liquid crystal capacitor electrically connected to the switching transistor and a storage capacitor electrically connected to the switching transistor.

The timing controller 120 receives image data signals R, G and B and various control signals, such as a vertical synchronization signal Vsync, a horizontal synchronization signal Hsync, a main clock signal MCLK, a data enable signal DE, etc., to control the image data signals R, G and B. In response to the control signals, the timing controller 120 outputs the image data signals R′, G′ and B′ obtained by processing the image data signals R, G and B in light of the operating conditions of the liquid crystal panel 110 and a horizontal start signal STH, a clock signal HCLK, and a line latch signal TP that are supplied to the data driver 140. The timing controller 120 also outputs a first vertical start signal STV1, a first gate clock signal CPV1 and an output enable signal OE to the first gate driver 150L and outputs a second vertical start signal STV2, a second gate clock signal CPV2 and the output enable signal OE to the second gate driver 150R.

The gray-scale voltage generator 130 generates a pair of gray-scale voltages relating to a transmittance of the liquid crystal panel 110. One of the gray-scale voltages has a positive value with respect to a common voltage VCOM and another gray-scale voltage has a negative value with respect to the common voltage VCOM.

The data driver 140 provides the data lines D1-Dm with the gray-scale voltage from the gray-scale voltage generator 130 in response to the horizontal start signal STH, the clock signal HCLK and the image data signals R′, G′ and B′.

The power supply 160 generates voltages needed to drive the liquid crystal display 100. In the exemplary embodiment, voltages generated by the power supply 160 may include a common voltage VCOM, a gate-on voltage VON and a gate-off voltage VOFF.

In response to the control signals from the timing controller 120, the first and second gate drivers 150L and 150R drives the gate lines G1-G3n with the common voltage VCOM, the gate-on voltage VON and the gate-off voltage VOFF. The first gate driver 150L is disposed at a left side of the liquid crystal panel 110 and electrically connected to some of the gate lines, e.g. the odd-numbered gate lines G1, G3, . . . , G3n-1. The second gate driver 150R is disposed at a right side of the liquid crystal panel 110 and electrically connected to the remaining gate lines, e.g. the even-numbered gate lines G2, G4, . . . , G3n.

When the gate-on voltage VON is applied to one of the gate lines G1-G3n, switching devices electrically connected to the gate line to which the gate-on voltage VON is applied are turned on, so that the data driver 140 provides the data lines D1-Dm with the gray-scale voltages corresponding to the image data signals. The gray-scale voltages provided to the data lines D1-Dm are applied to corresponding pixels via the turned-on switching devices. Switching devices that are electrically connected to the gate line are turned on in response to receiving the gate-on voltage VON. Generally, a period during which the switching devices are turned on is identical to one period of the data enable signal DE and the first or second gate clock signal CPV1 or CPV2, and called “one horizontal period” or “1H”. Thus, since a number of the gate lines G1-G3n corresponds to three times a horizontal resolution of the liquid crystal panel 110, the gate-on voltage VON is applied to one gate line of the gate lines G1-G3n during a period of about 1H/3. In an exemplary embodiment of the invention, the data lines D1-Dm are driven by a pre-charge driving method whereby the gate lines G1-G3n are driven such that the pixels PX connected to a next data line are precharged while the image data signals R′, G′ and B′ are applied to the pixels PX connected to a current gate line. For the pre-charge driving method of the data lines D1-Dm, the gate-on voltage VON is applied to a next gate line of the gate lines G1-G3n during a period of about ⅔*H and overlapped with the gate-on voltage VON applied to a previous gate line during a later period of about ⅓*H. The pre-charge driving method may compensate for the reduced charging time of the liquid crystal capacitor due to an increase of number of the gate lines G1-G3n.

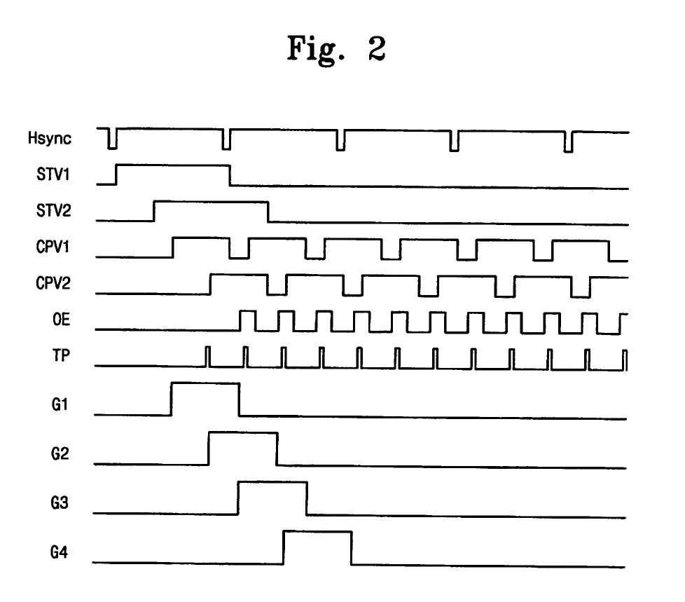

FIG. 2 is a timing diagram showing signals for the liquid crystal display of FIG. 1.

Referring to FIG. 2, in order to drive the gate lines G1-G3n by the pre-charge driving method, the data lines D1-Dm are driven by a column inversion driving method. In accordance with the column inversion driving method, the gray-scale voltage is applied to the pixels through the data lines D1-Dm allowing the pixels that are electrically connected to a same data line to have the same polarity. For example, assuming that the pixels electrically connected to odd-numbered data lines receive the gray-scale voltage having a positive polarity, the pixels electrically connected to even-numbered data lines would receive the gray-scale voltage having a negative polarity, and vice versa.

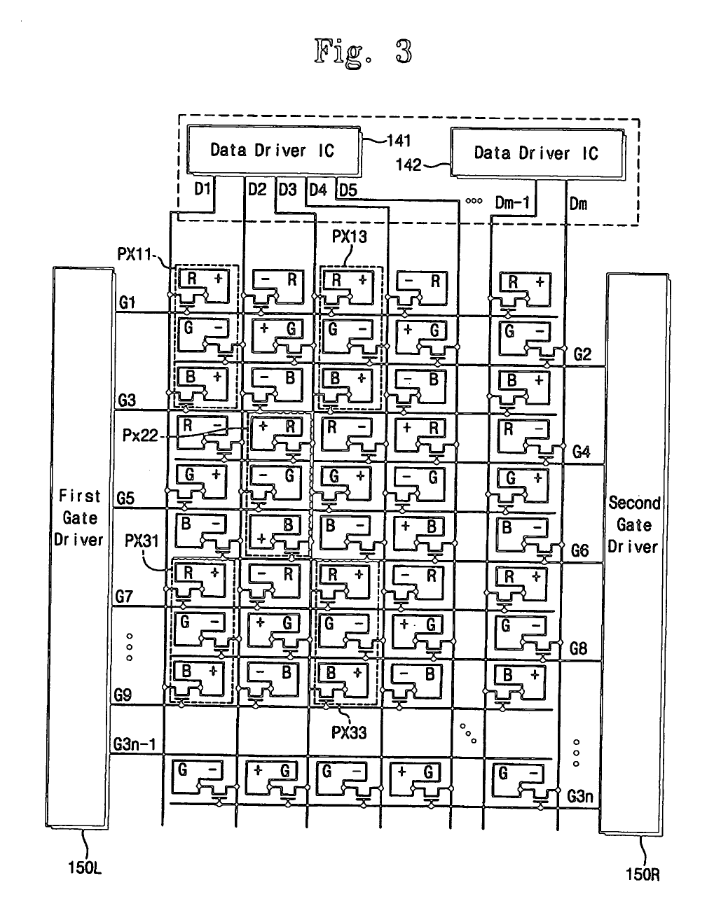

FIG. 3 is a circuit diagram showing subpixels in the liquid crystal panel of FIG.

Referring to FIG. 3, each of the pixels in the liquid crystal panel 110 includes three subpixels such as a red subpixel, a green subpixel and a blue subpixel and three switching transistors electrically connected to the three subpixels, respectively. Each of the switching transistors is electrically connected to a corresponding data line of the data lines D1-Dm and to a corresponding gate line of the gate lines G1-G3n. In a conventional liquid crystal panel, the subpixels R, G and B are arranged in a second direction in which the gate lines G1-G3n extend, but the subpixels R, G and B according to the exemplary embodiment are arranged in a first direction in which the data lines D1-Dm extend. In the exemplary embodiment, the subpixels R, G and B sequentially arranged in that order will be described. However this is not a limitation of the invention and the subpixels R, G and B may be arranged in any desired order such as RBG, GBR, GRB, BRG, BGR, etc.

As shown in FIG. 3, the liquid crystal panel 110 on which the subpixels R, G and B are formed along the data lines D1-Dm has a smaller number of data lines D1-Dm than that of the liquid crystal panel on which the subpixels R, G and B are formed along the gate lines G1-G3n. Particularly, the number of the data lines D1-Dm of the liquid crystal panel 110 on which the subpixels R, G and B are formed along the data lines D1-Dm may be reduced to about two-thirds compared to the liquid crystal panel 1 10 on which the subpixels R, G and B are formed along the gate lines GI-G3n. As a result, the number of data driver integrated circuits 141 and 142 in the data driver 140 may be reduced to about two-thirds of the data lines D1-Dm. Thus, a manufacturing cost and an area of the liquid crystal display may be reduced.

Referring to FIG. 3, the subpixels R, G and B are sequentially arranged in the direction in which the data lines D1-Dm extend. A first group of the subpixels R, G and B is electrically connected to a data line to its left side and a second group of the sub pixels R, G and B is electrically connected to a data line to its right side. Particularly, the switching transistors of the subpixels electrically connected to the odd-numbered gate lines G1, G3, G5, . . . , G3n-1 that are driven by the first gate driver 150L are electrically connected to the data line to their left side, and the switching transistors of the subpixels electrically connected to the even-numbered gate lines G2, G4, G6, . . . , G3n that are driven by the second gate driver 150R are electrically connected to the data line to their right side. That is, the switching transistors of the subpixels R, G and B electrically connected to a first gate line G1 are electrically connected to the data line to their left side, and the switching transistors of the subpixels R, G and B electrically connected to a second gate line G2 are electrically connected to the data line to their right side.

According to the connection between the subpixels R, G and B and the data lines D1-Dm, although the data lines D1-Dm are driven by the column inversion driving method using the data driver 140, the subpixels R, G and B are driven in a dot inversion method. That is, the gray-scale voltages respectively applied to the subpixels adjacent to each other have a different and complementary polarity. When a liquid crystal display is driven by what appears as the dot inversion, a voltage difference between when the gray-scale voltage has the positive polarity and when the gray-scale voltage has the negative polarity due to a kick-back voltage may be reduced, thereby preventing brightness difference and a vertical stripe flicker.

When the data lines D1-Dm are driven by a conventional column inversion driving method, the vertical stripe flicker may appear on the liquid crystal panel 310 shown in FIG. 3. The reason for the vertical stripe flicker is that each of the subpixels R, G and B among the subpixels R, G and B arranged in the first direction may have the gray-scale voltage having the same polarity as adjacent subpixels R, G and B. However, in the invention the liquid crystal panel 410 appears as though it is driven by the dot inversion method. Thus, the vertical stripe flicker of the liquid crystal panel 410 may be prevented.

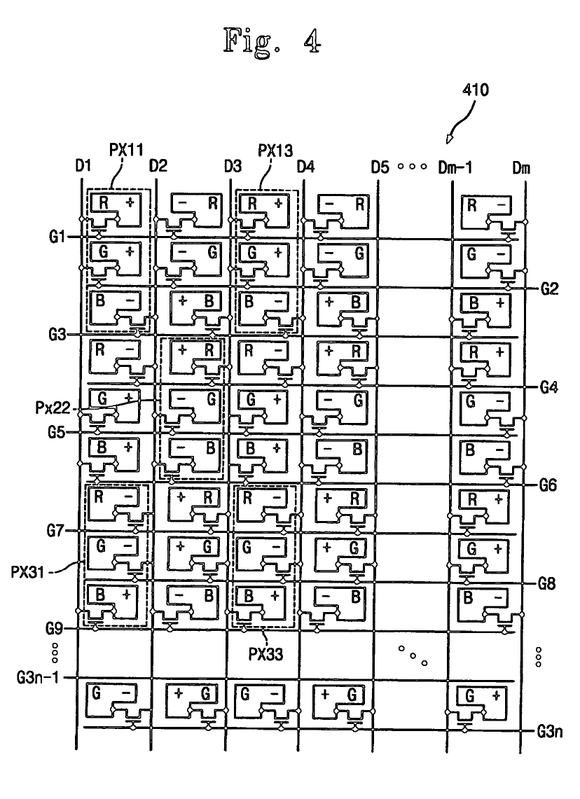

FIG. 4 is a circuit diagram showing a liquid crystal display according to another exemplary embodiment of the present invention.

Referring to FIG. 4, the subpixels R, G and B are sequentially arranged in a first direction in which the data lines D1-Dm extend, and they are alternately connected to the data lines D1-Dm. Unlike in the embodiment of FIG. 3 where every other subpixel is connected to the same data line, every other pair of subpixels R, G and B is connected to the same data line in this embodiment. For example, a first group of the subpixels R, G and B is connected to a data line to its left side and a second group of the subpixels R, G and B is connected to a data line to its right side. In the embodiment illustrated in FIG. 4, the switching transistors of two subpixels R and G that are connected to first and second gate lines G1 and G2, respectively, are electrically connected to the data line to their left side. Similarly, the switching transistors of two subpixels B and R connected to the third and fourth gate lines G3 and G4, respectively, are electrically connected to the data line to their right side.

As shown in FIG. 4, in order to reduce screen-defects, the pixels of the liquid crystal panel 410 are driven by the dot inversion driving method such that the pixels having the subpixels R, G and B receive image data signals having polarities that are different from those of the adjacent pixels. That is, the pixel PX22 has a different gray-scale polarity from those of pixels PX11, PX13, PX31 and PX33 that are diagonally adjacent to the pixel PX22, thereby reducing screen-defects. More specifically, the subpixels R, G and B of the pixel PX22 have gray-scale polarities of plus (+), minus (−) and minus (−), respectively. However, the subpixels R, G and B of each pixels PX11 and PX13 diagonally-adjacent to the pixel PX22 have gray-scale polarities of plus (+), plus (+) and minus (−), respectively. Likewise, the subpixels R, G and B of each pixels PX31 and PX33 diagonally-adjacent to the pixel PX22 have gray-scale polarities of minus (−), minus (−) and plus (+), respectively. These are different from the gray-scale polarities of the pixels PX11, PX13, PX22, PX31 and PX33 of the liquid crystal panel 410 shown in FIG. 3.

In FIG. 4, a first group including a pair of subpixels and the second group including another pair of subpixels are alternately connected to two data lines that are adjacent to these subpixels. However, the “alternating pair” embodiment is just an example of the invention and the first and second groups may each have three or more subpixels in other embodiments without straying from the scope of the invention.

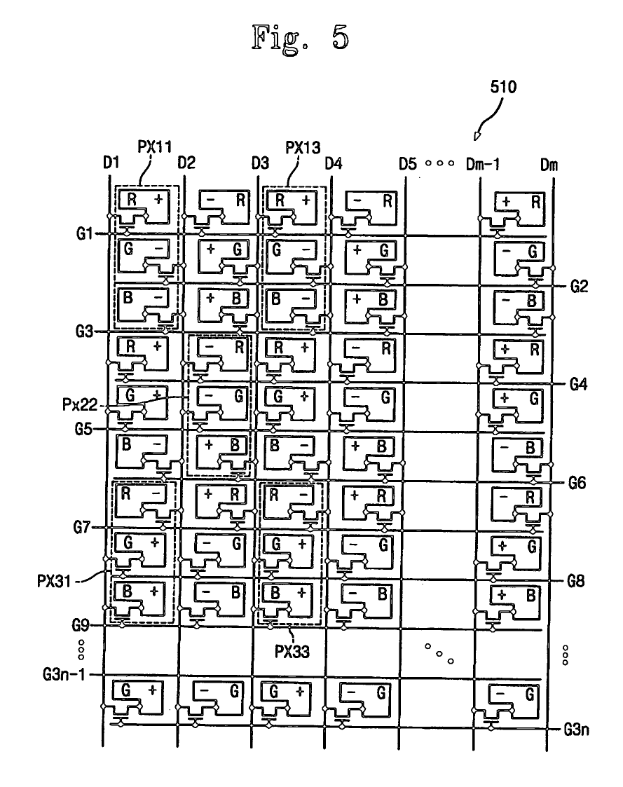

FIG. 5 is a circuit diagram showing a liquid crystal display according to another exemplary embodiment of the present invention.

Referring to FIG. 5, the subpixels R, G and B are sequentially arranged in a first direction in which the data lines D1-Dm extend, and the subpixels R, G and B are alternately connected to the data lines D1-Dm. Pairs of subpixels are alternately connected to two adjacent data lines except that a first subpixel is electrically connected to a first gate line G1 alone. In the present embodiment, when a first group of the subpixels R, G and B is connected to a data line to its left side, a second group of the subpixels R, G and B is connected to a data line to its right side such that each of the data lines D1-Dm has every other pair of subpixels arranged in a line connected to it (with the exception of the first subpixel). Further, when the first subpixel is connected to a data line to its left side, the first group of the subpixels R, G and B following the first subpixel is connected to the data line to its right side and the second group of the subpixels R, G and B is connected to the data line to its left side. On the other hand, when the first subpixel is connected to the data line to its right side, a first group of the subpixels R, G and B following the first subpixels is connected to the data line to its left side, and the second group of the subpixels R, G and B is connected to the data line to its right side.

In the present embodiment, since the first subpixel connected to the first gate line G1 is electrically connected to the data line to its left side, the subpixels R, G and B connected to the gate lines G1, G4, G5, G8, G9, . . . are connected to the data line to their left side, and the subpixels R, G and B connected to the gate lines G2, G3, G6, G7, G10, . . . are connected to the data line to their right side.

As shown in FIG. 5, in order to reduce screen-defects, the pixels of the liquid crystal panel 410 are driven by the dot inversion driving method such that the pixels having the subpixels R, G and B receive image data signals having polarities different from those of adjacent pixels.

That is, the pixel PX22 has a different gray-scale polarity from those of adjacent pixels PX11, PX13, PX31 and PX33, thereby reducing screen-defects. Particularly, the subpixels R, G and B of the pixel PX22 have gray-scale polarities of minus (−), minus (−) and plus (+), respectively. However, the subpixels R, G and B of each pixels PX11 and PX13 adjacent to the pixel PX22 have gray-scale polarities of plus (+), minus (−) and minus (−), respectively, and the subpixels R, G and B of each pixels PX31 and PX33 adjacent to the pixel PX22 have gray-scale polarities of minus (−), plus (+) and plus (+), respectively. These are different from the gray-scale polarities of the pixels PX11, PX13, PX22, PX31 and PX33 of the liquid crystal panel 410 shown in FIG. 3.

Although the subpixels are driven by the column inversion driving method, the liquid crystal display panel does not suffer from an appearance of a vertical stripe flicker since the subpixels are sequentially arranged in the direction in which the data lines extend. Further, the subpixels are connected to the data lines to their left and right sides in an alternating manner, thereby reducing screen-defects when the liquid crystal panel is driven by the dot inversion type.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A liquid crystal display comprising:
a plurality of data lines;
a plurality of gate lines extending perpendicularly to the data lines to define a plurality of pixel regions; and
a pixel array including a plurality of pixels, each of the pixels having a plurality of subpixels corresponding to a red, a green and a blue and arranged along a direction in which the data lines extend, the subpixels being formed in the pixel regions,
wherein first groups of the subpixels are connected to an adjacent left data line, second groups of the subpixels are connected to an adjacent right data line, and the data lines are driven by a column inversion driving method such that image data applied to the adjacent data lines have different polarities.

2. The liquid crystal display of claim 1, wherein the first groups of the subpixels and the second groups of the subpixels are alternately arranged along the direction in which the data lines extend.

3. The liquid crystal display of claim 1, wherein the first groups of the subpixels are connected to every other gate lines among the plurality of gate lines, and the second groups of the subpixels are connected to the gate lines that are not connected to the first groups of the subpixels.

4. The liquid crystal display of claim 1, wherein each of the first groups has K (K is a positive integer) units of the subpixels, each of the second groups has K units of the subpixels and the first and second groups are alternately arranged along the direction in which the data lines extend.

5. The liquid crystal display of claim 4, wherein the first groups of the subpixels are connected to every other gate lines among the plurality of gate lines, and the second groups of the subpixels are connected to the gate lines that are not connected to the first groups of the subpixels.

6. The liquid crystal display of claim 1, wherein each of the first groups has two subpixels, each of the second groups has two subpixels and the first and second groups are alternately arranged along the direction in which the data lines extend.

7. The liquid crystal display of claim 6, wherein the first groups of the subpixels are connected to I-th gate line and (I+1)-th gate line and the second groups of the subpixels are connected to (I+2)-th gate line and (I+3)-th gate line, wherein I=4 k+1 (k is a positive integer including 0).

8. The liquid crystal display of claim 1, wherein the first and second groups of the subpixels are connected to the gate lines except a first gate line of the gate lines, each of the first groups has K (K is a positive integer) units of the subpixels, each of the second groups has K units of the subpixels, and the first and second groups are alternately arranged along the direction in which the data lines extend.

9. The liquid crystal display of claim 1, wherein the gate lines are driven such that the subpixels connected to a next data line are precharged while the image data is applied to the subpixels connected to a current gate line.

10. A liquid crystal display comprising:
a plurality of data lines;
a plurality of gate lines extending substantially perpendicularly to the data lines to define a plurality of pixel regions; and
a pixel array including a plurality of pixels, each of the pixels having a plurality of subpixels corresponding to a red, a green and a blue and being arranged along a direction in which the data lines extend, the subpixels being formed in the pixel regions,
wherein a first group having K (K is a positive integer) units of the subpixels is connected to an adjacent left data line, a second group having K units of the subpixels is connected to an adjacent right data line, the first and second groups are alternately arranged along a direction in which the data lines extend, and the data lines are driven by a column inversion driving method such that image data applied to the adjacent data lines have different polarities.
